(19) United States
(12) Patent Application Publication
(10) Pub. No.: US 2024/0107304 A1
(43) Pub. Date: Mar. 28, 2024

(54) REDUCED FILE TRANSFER PROTOCOL METHODS AND SYSTEMS

(71) Applicant: THE UNITED STATES OF AMERICA, AS REPRESENTED BY THE SECRETARY OF THE NAVY, Arlington, VA (US)

(72) Inventors: Blake Alexander Hayden, Canton, SD (US); Britta Jean Hale, Monterey, CA (US)

(21) Appl. No.: 18/369,664

(22) Filed: Sep. 18, 2023

Related U.S. Application Data
(60) Provisional application No. 63/407,433, filed on Sep. 16, 2022.

(51) Int. Cl. H04W 12/06; H04W 12/106

(52) U.S. Cl. CPC H04W 12/06; H04W 12/106

(57) ABSTRACT

Methods and systems for reduced file transfer protocols are disclosed, Provided are methods and systems for implementation for securing software updates to satellites and remote locations under power, bandwidth, or frequency limitations, using cryptographic protocols for different components of a delivery architecture for a large data payload, such as for a software update, from a trusted, back-end (terrestrial) source to receivers: a low-response protocol for initial transmission and confirmation (BAC protocol), and two possible inter-unit distribution protocols (COCO-SYNC-R protocol (Pull) or COCO-SYNC-P (PUSH)) with differing optimizations based on connectivity scenarios. These protocols introduce a means for accounting for both security (authentication) and efficacy (minimized RF footprint) in the delivery of critical data payloads to remote receivers.

### CROSS REFERENCE TO RELATED PATENT(S) AND APPLICATION(S)

This application claims the benefit of U.S. Provisional Application No. 63/407,433, filed Sep. 16, 2022, and entitled Reduced RF File Transfer Protocols, which is hereby incorporated in its entirety by reference.

### BACKGROUND

This disclosure, and the exemplary embodiments described herein, describe methods and systems for reduced file transfer protocols. The implementation described herein is related to systems and methods for implementation for securing software updates to satellites and remote locations under power, bandwidth, or frequency limitations. However it is to be understood that the scope of this disclosure is not limited to such applications.

As the reliance on space systems increases and space-based architectures become more agile to the computerized infrastructure common among terrestrial systems, the challenge of delivering large data payloads, such as software updates, becomes more prominent. Cyber capabilities and equipment continue to advance, and large file transfer to remote devices, such as in patching software vulnerabilities, are becoming the status quo. The power cost and data transfer challenges associated with ground-to-space communications, e.g., from the ground segment to low-Earth orbit (LEO) or geostationary equatorial orbit (GEO), incentivize an intra-satellite option for propagating such updates. While work has been done to optimize transport at the physical layer, current security protocol requirements at the application layer incur interaction between devices and can force weight on the delivery architecture.

This disclosure and the example embodiments disclosed herein discloses three cryptographic protocols for different components of a delivery architecture for a large data payload, such as for a software update, from a trusted, back-end (terrestrial) source to receivers: a low-response protocol for initial transmission and confirmation, and two possible inter-unit distribution protocols with differing optimizations based on connectivity scenarios. These protocols introduce a means for accounting for both security (authentication) and efficacy (minimized RF footprint) in the delivery of critical data payloads to remote receivers.

Furthermore, in the new ever-changing cyber domain, it is crucial that the military establishes a method of delivering large data payloads to remote locations that minimizes radio frequency (RF) signature for receivers, thereby reducing the associated geolocation potential. The disclosed three cryptographic protocols are used for different components of a delivery architecture for a large data payload from a trusted, back-end source to receivers: a low-response protocol for initial transmission and confirmation and two possible inter-unit distribution protocols with differing optimizations based on connectivity scenarios. All three protocols expressly aim to minimize the radio frequency (RF) footprint created on the receiver end. These protocols introduce a means for accounting for both security (authentication) and safety (minimized RF footprint) in the delivery of critical data payloads to remote receivers.

### INCORPORATION BY REFERENCE

The following publications are incorporated by reference in their entirety.
[Ref. 1] B. Sklar, Digital communications: fundamentals and applications., 2nd ed. Upper Saddle River, N.J: Prentice-Hall PTR, 2001.
[Ref. 2] P. Tedeschi, S. Sciancalepore, and R. Di Pietro Satellite-based communications security: A survey of threats, solutions, and research challenges Computer Networks, vol. 216, p. 109246, 2022.
[Ref. 3] L. Catuogno, C. Galdi, and G. Persiano, Secure Dependency Enforcement in Package Management Systems. IEEE Transactions on Dependable and Secure Computing, vol. 17, no. 2, pp. 377-390, 2020.
[Ref. 4] S. Falas, C. Konstantinou, and M. K. Michael, A Modular End-to-End Framework for Secure Firmware Updates on Embedded Systems. ACM Journal on Emerging Technologies in Computing Systems (JETC), vol. 18, no. 1, pp. 1-19, 2021.
[Ref. 5] J. Benet, IPFS—Content Addressed, Versioned, P2P File System. 2014.
[Ref. 6] N. Suri et al., Disservice: a peer-to-peer disruption tolerant dissemination service. In MILCOM 2009-2009 IEEE Military Communications Conference. IEEE, 2009, pp. 1-8.
[Ref. 7] B. Hayden, M. Sweeney, and B. Hale, Securing Software Updates under Receiver Radio Frequency Geolocation Risk. In MILCOM 2022 IEEE Military Communications Conference. IEEE, 2022.

### BRIEF DESCRIPTION

In accordance with one exemplary embodiment of the present disclosure, disclosed is a method for transferring a complete message from a back-end unit to a plurality of receiving units, the complete message including a plurality of interactive packets, each packet including a subsection of the complete message, the method comprising: the back-end unit authenticating each of the interactive packets and generating authentication data for each of the interactive packets; the back-end authenticating the complete message and generating authentication data for the complete message; the back-end unit sending the complete message, including the iterative packet authentication data and the complete message authentication data, to a plurality of receiving units using at least one radio frequency (RF) link; the back-end unit receiving a confirmation response from exactly one of the plurality of receiver units, wherein the confirmation response describes an updated status of each of the receiver units, the updated status of each of the receiver units includes a message indicating one or more of 1) the complete message was received by all receiver units, and 2) an identifier of the iterative packets not received by one or more receiving units; and the back-end unit sending only the iterative packets not received by one or more of the receiver units, wherein the plurality of receiver units includes at least one receiver unit which communicates with the other receiver units to acquire the update status of the sent complete message for each of the plurality of other receiver units, and the at least one receiver communicates the update status to the back-end sending unit.

In accordance with another exemplary embodiment of the present disclosure, disclosed is a satellite communication system including a back-end unit, and a plurality satellites configured to communicate with the back-end unit, wherein the plurality of satellites each include a receiving unit and are configured to communicate with one or more of the other satellites, the satellite communication system performing a method for transferring a complete message from the back-end unit to the plurality of satellite receiving units, the complete message including a plurality of interactive packets, each packet including a subsection of the complete message, the method comprising: the back-end unit authenticating each of the interactive packets and generating authentication data for each of the interactive packets; the back-end authenticating the complete message and generating authentication data for the complete message; the back-end unit sending the complete message, including the iterative packet authentication data and the complete message authentication data, to a plurality of the satellite receiving units using at least one radio frequency (RF) link; the back-end unit receiving a confirmation response from exactly one of the plurality of the satellite receiver units, wherein the confirmation response describes an updated status of each of the satellite receiver units, the updated status of each of the satellite receiver units includes a message indicating one or more of 1) the complete message was received by all satellite receiver units, and 2) an identifier of the iterative packets not received by one or more satellite receiving units; and the back-end unit sending only the iterative packets not received by one or more of the satellite receiver units, wherein the plurality of satellite receiver units include at least one satellite receiver unit which communicates with the other satellite receiver units to acquire the update status of the sent complete message for each of the plurality of other satellite receiver units, and the at least one satellite receiver communicates the update status to the back-end sending unit.

In accordance with another exemplary embodiment of the present disclosure, disclosed is a satellite communication system including a back-end unit, a plurality of mobile receiving units, and a satellite configured to communicate with the back-end unit and communicate with one or more of the plurality of mobile receiving units, and wherein the plurality of mobile receiving units are configured to communicate with one or more of the other mobile receiving units, the satellite communication system performing a method for transferring a complete message from the back-end unit to the plurality of mobile receiving units, the complete message including a plurality of interactive packets, each packet including a subsection of the complete message, the method comprising: the back-end unit authenticating each of the interactive packets and generating authentication data for each of the interactive packets; the back-end authenticating the complete message and generating authentication data for the complete message; the back-end unit and satellite sending the complete message, including the iterative packet authentication data and the complete message authentication data, to a plurality of the mobile receiving units using at least one radio frequency (RF) link; the back-end unit receiving a confirmation response from exactly one of the plurality of the mobile receiver units, wherein the confirmation response describes an updated status of each of the mobile receiver units, the updated status of each of the mobile receiver units includes a message indicating one or more of 1) the complete message was received by all mobile receiver units, and 2) an identifier of the iterative packets not received by one or more mobile receiving units; and the back-end unit sending only the iterative packets not received by one or more of the mobile receiver units, wherein the plurality of mobile receiver units include at least one mobile receiver unit which communicates with the other mobile receiver units to acquire the update status of the sent complete message for each of the plurality of other mobile receiver units, and the at least one mobile receiver communicates the update status to the back-end sending unit.

### BRIEF DESCRIPTION OF THE DRAWINGS

For a more complete understanding of the present disclosure, reference is now made to the following descriptions taken in conjunction with the accompanying drawings.

FIG. 1 is a simplified satellite view where LEO and GEO satellites are at approximately 700 and 36,000 kilometers, respectively. Each numbered line represents a one-directional/bi-directional channel between neighboring layers. According to an example embodiment, lines 1, 2, 3, 4, 5 and 7 provide channels for Back-haul Authenticated Control, and lines 6, 8, 9 and 10 provide channels for COCO-SYNC-R (PULL) or COCO-SYNC-P (PUSH) protocols.

FIG. 2 is a simplified view of a satellite communication system including a back-end unit, and a plurality satellites configured to communicate with the back-end unit, wherein the plurality of satellites each include a receiving unit and are configured to communicate with one or more of the other satellites. Back-haul Authenticated Control (BAC) protocol (A/C) covers initial transmission of data and confirmation of receipt, while the COCO-SYNC-R (PULL) or COCO-SYNC-P (PUSH) protocols (B) cover inter-unit distribution.

FIG. 3A is an algorithmic illustration of a BAC protocol and FIG. 3B is an illustration of a confirmation message according to this disclosure.

FIG. 4 shows a BAC protocol according to an example embodiment of this disclosure.

FIG. 5A is an algorithmic illustration of a COCO-SYNC-R protocol and FIG. 5B is a flow illustration of a COCO-SYNC-R protocol according to this disclosure.

FIG. 6A is an algorithmic illustration of a COCO-SYNC-P protocol and FIG. 6B is a flow illustration of a COCO-SYNC-P protocol according to this disclosure.

FIG. 7 depicts a satellite communication system including a back-end unit and a plurality of terrestrial mobile receiving units, where a BAC protocol covers initial transmission of data, while the COCO-SYNC-R or COCO-SYNC-P protocols cover inter-mobile-unit distribution.

### DETAILED DESCRIPTION

This disclosure and exemplary embodiments described herein methods and systems for reduced file transfer protocols. The implementation described herein is related to systems and methods for implementation for securing software updates to satellites and remote locations under power, bandwidth, or frequency limitations, using cryptographic protocols for different components of a delivery architecture for a large data payload, such as for a software update, from a trusted, back-end (terrestrial) source to receivers: a low-response protocol for initial transmission and confirmation (BAC protocol), and two possible inter-unit distribution protocols (COCO-SYNC-R protocol (Pull) or COCO-SYNC-P (PUSH)) with differing optimizations based on connectivity scenarios. These protocols introduce a means for accounting for both security (authentication) and efficacy (minimized RF footprint) in the delivery of critical data payloads to remote receivers. However it is to be understood that the scope of this disclosure is not limited to such applications.

### 1. Satellite Communication System

As space systems and the network of space continues to grow at scale, the unique and increasingly complex communications' environments calls for a new paradigm in application layer security design. These environments suffer from restricted communication pathways, such as temporary one-way communication links, disruption, delays, and significant power considerations that limit synchronous data transmission. Furthermore, these environments are characterized by devices spread out and separated for extended periods. In addition to the physical considerations of such environments comes of the cyber needs: devices will increasingly require authenticated large file transfers, such as in the sending of software updates or images.

Space Application

a) Figures of Merit for Space Communication Systems: With a space communications architecture, the ground segment is often less resource-constrained, i.e., a ground station for a satellite constellation, the terrestrial sending unit can provide more power (and therefore, gain). This allows the space segment—due to the desire to minimize size, weight, and power constraints on the spacecraft—to minimize its power requirements to meet the desired data rate.

This can be seen in Equation 1 where, due to the free-space path loss Lₛ, the link margin decreases as the distance between the transmitter and receiver increases.

$$M = \frac{EIRP \frac{G}{T}}{\frac{{E}_{b}}{{N}_{o}} R κ {L}_{s} {L}_{o}} \qquad ( 1 )$$

As a result, this typically leads to lower data rates to transmit data from a ground segment to the spacecraft to ensure that the spacecraft can be successfully commanded. Higher data rates are employed to receive data on the ground from the space segment, as the quantity of data being transmitted is also higher.

Here, the overall link margin, M, is used to evaluate the performance for a communications system, where EIRP is the effective radiated power, G is the gain of the receiving antenna, T is the effective system temperature, E_{b} is the bit energy, Nₒ is the noise power spectral density, R is the bit rate, κ is the Boltzmann constant, Lₛ is the free-space path loss, and Lₒ is other losses due to weather effects, pointing accuracy, and so on. See [Ref. 1].

Within the link margin equation, several terms are grouped together as figures of merit that are used to assess the trade-offs associated with communication system architectures. G/T is a figure of merit that indicates the performance of the receiver, and Eb/No describes the energy required to achieve a certain data rate. See [Ref. 1]. This equation highlights the intrinsic intertwining of communications and bandwidth/power considerations. While traditional approaches look at necessary power to achieve communication, this work looks at how strategic design of the communication protocols can optimize performance even under power/bandwidth limitations.

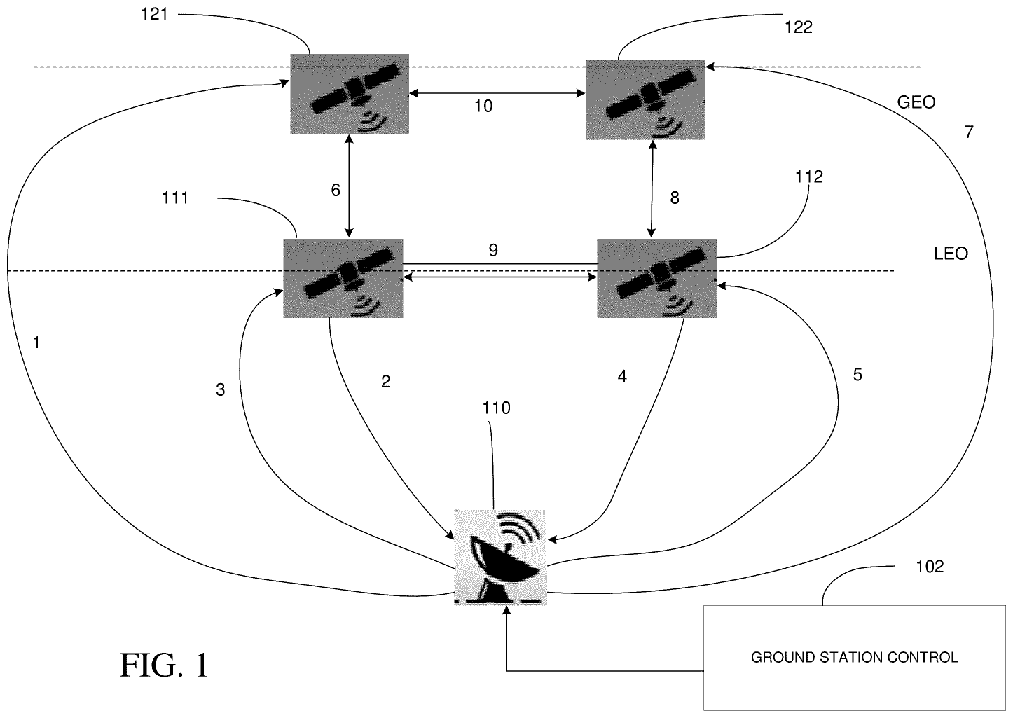

b) Near Space: In an application of the disclosed protocols to satellite communications, FIG. 1 depicts a simplified view of the satellite layers-a low-earth orbit (LEO) layer and a geostationary (GEO) layer—with terrestrial sending units (T) 110, ground station control 102, and satellites 111, 112, 121 and 122. According to this example, LEO and GEO satellites 111, 112, 121 and 122 are at approximately 700 and 36,000 kilometers, respectively. Each numbered line represents a one-directional channel between neighboring layers, and each data pathway is numbered for reference. In the diagram, the uplink channels (1, 3, 5, 7) are the most constrained with regard to bandwidth ability and power requirements to receive data on-orbit. In contrast, the downlink and inter-satellite communication (2, 4, 6, 8, 9, and 10) operate with relatively less restrictions with respect to data transmission.

In normal transmission protocols, communication between any two devices requires interaction, such as a series of confirmation messages on receipt. Given this, and the relative restrictions on the links depicted, it is natural to observe a strategy for optimization of the space-to-ground link, e.g., a transmission from a LEO constellation to a terrestrial ground station, where the satellites are the original senders and act as the back-end, and the ground segment contains the receivers. An example of this use case would be data-collecting satellites that need to transmit their data back to a ground site.

c) Deep Space: Another example space application is transmitting large data payloads like updates to deep space probes. In this scenario, the RF channels can be constrained in both directions between transmitter and receiver due to the difficulty of maintaining satellite alignment at great distances. Although the link budget is much more constrained in this application, the situation is identical in that the data downlink (receivers to the back-end) has a higher data rate requirement than the command uplink (back-end to the receivers).

Updating software is not a new concept, but while the size of software and updates have continued to grow, there has not been any rigorous attempts to provide authenticated updates over LPB/RF-constricted channels. Some operational systems, e.g., GEO systems, are designed to last years, if not decades. As this gear must resist cyberattacks and ever-evolving adversarial techniques, there are new security concerns that must be corrected with updates. While this presents a clear need for methods for updating software and is true for terrestrial and GEO systems, LEO space systems operate on a different paradigm that may make the need less obvious.

As highlighted by proliferated LEO (pLEO) satellite constellations such as ONEWEB and STARLINK, which range from hundreds to thousands of active satellites on-orbit at any given time, it is expected that these satellites de-orbit within a few years. Additionally, due to the use of smaller satellites in LEO for many commercial solutions, it is currently considered more cost-effective to replace satellites as they de-orbit, as this allows the hardware to be upgraded as well. However, if software updates could be provided more easily and securely, there would be more motivation to keep these spacecraft active, thus increasing on-orbit capabilities and the resiliency of these systems to unexpected cyberattacks. Furthermore, new techniques and uses, such as on-device machine learning, can create a need to update models regularly, before de-orbit. Prior work has indicated that cryptographic protocols for inter-satellite communications is an area of interest as the effectiveness of physical-layer techniques for satellite communications security is not clear. See [Ref. 2]. Given the increase in systems in the space domain and consequent risk of system-to-system attacks (vs. ground to space system), reliance solely on physical layer obfuscation techniques—included as a basic expectation terrestrially and with further cryptographic security layers on top—may undermine basic risk management.

Previous methods and policies of updating remote equipment are discussed in [Ref. 3], which offers a “comprehensive mechanism for security and reliability in software deployment”. The authors' approach focuses on confidentiality and authenticity, ensuring that the installation process is not viewable and that only required packages get installed. However, additional LPB/RF constraints indicate that the proposed method does not satisfy the environment setting requirements for the space domain.

Recently, the community has considered methods of securely updating firmware on remote embedded devices (EDs), see [Ref. 4], in an approach that is specifically designed for EDs that operate without an operating system. That approach relies on cryptographic primitives that run directly on the hardware. It works by establishing a session key with the update provider, receiving the update, and then verifying it on hardware. which is not desirable for a LPB/RF constrained environment where minimization of interaction and synchronicity to the back-end is required.

In other works, a peer-to-peer (P2P) approach to file sharing in an Internet-of-Things network is detailed, termed the InterPlanetary File System (IPFS). See [Ref. 5]. IPFS provides a means to share information among dispersed nodes and also provides for versioning of its files and routing information to enable web-like sharing. However, some of its features such as version control and Merkle DAG objects introduce expensive consensus communication that is not necessary for our situation as the back-end is completely trusted.

Another P2P data sharing protocol that focuses on reliable delivery of data in unreliable, distributed networks is DisService. See [Ref. 6]. However, it is not a security protocol nor does it consider the authentication and authorization issues that are addressed in this disclosure, including entity authentication to and from the back-end and data authentication. Rather, like IPFS which carries strong similarities, it looks at utilizing data caching. In addition to lacking security considerations, DisService, like IPFS, does not address minimization of the transmissions among peers for LPB/RF constrained systems. Thus, this disclosure, and the example embodiments described herein, not only provides consideration of security that is missing from prior works, but an entirely new P2P data sharing feature in minimization of LPB/RF constraints.

This disclosure provides a new software update protocol, comprised of three sub-protocols, that securely delivers an update to a group of participants while minimizing the LPB/RF requirements of the participants. Specifically, the update protocol includes:
1) Back-haul Authenticated Control (BAC) Protocol: A software update protocol providing authenticated messages from a back-end to receiver participants as well as a push-button option for selective confirmation response on the received message.
2) Constrained Communication Synchronization-Request (COCO-SYNC-R) Protocol: A packet sharing protocol for distribution and confirmation of receipt of the update amongst forward participants. This protocol utilizes a pull method for sharing packets.
3) Constrained Communication Synchronization-Provide (COCO-SYNC-P) Protocol: A packet sharing protocol for distribution and confirmation of receipt of the update amongst forward participants. This protocol utilizes a push method where one unit broadcasts to all other units.

In addition provided herein is a Power and Bandwidth Analysis, including mathematical bounds for transmission costs on the above protocols.

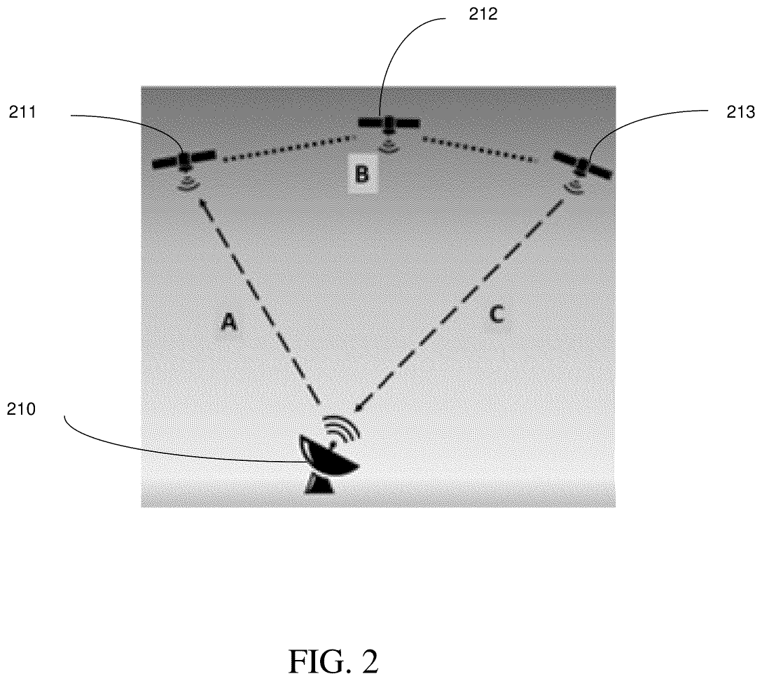

The three protocols provided in this disclosure are as follows. The first, called Back-haul Authenticated Control (BAC), governs the authenticated data transfer from the back-end to the receiving units. The other two protocols are alternatives that govern inter-unit communication for data sharing among the receiver units. First, described is the Constrained Communication Synchronization-Request (COCO-SYNC-R) protocol, which utilizes a “pull” mechanism. Second, and second described is a “push” mechanism alternative protocol, Constrained Communication Synchronization-Provide (COCO-SYNC-P). These protocol roles are illustrated in FIG. 2 with A/C indicating the BAC protocol, which covers initial transmission of data from the base sender 210 to satellites 211 and 213 and confirmation of receipt, and B indicating the COCO-SYNC-R protocol or COCO-SYNC-P protocol which covers inter-unit distribution among satellites 211, 212 and 213.

Since the primary concern is authentication from the back-end for the update, the use of asymmetric digital signatures is relied upon. Encryption is not provided within the protocol, but it should be noted that these protocols can be executed within an encrypted channel if confidentiality is desired.

In the protocols, FLOWs that contain a digital signature do not include an identity certificate from the sender. The protocol assumes that the receiver will have a list of public keys, including the back-end and receiver units, and will perform an exhaustive search on this list until it finds a key that verifies the tag (with the exception of confirmation messages which attest to the sender). While this is an additional computational cost, it allows a reduction in the bandwidth at the receiver end, so the added computation is acceptable. Additionally, the public key list maintained by the forward units will be relatively small (<1000) so the added time to compute in practice will be negligible. Note, however, that this search can be avoided by the protocol implementers by inclusion of the sender identity, if desired.

Notation and Variables

| | |
|---|---|
| BE | Back-end Sender |
| Uᵥ | Receiver |
| k | The number of receiver units participating in the protocol |
| Nᵥ | A fresh nonce sampled by Uᵥ, where Nᵥ ∈ {1, 0}* |
| Updateₓ | Numeric identifier for x-th update. This may also be interpreted as Seq_Update. We abuse notation and simply use |
| | Update, with the sequencing of further updates handled by the application. |
| M | Complete update message for the transmission |
| Seqₙ | Numeric sequence number for the n-th packet. This may also be interpreted as Seq_Packetₙ. |
| Seqₜₒₜₐₗ | Total number of packets included in transmission |
| BE → Uᵥ | sending data from BE to Uᵥ |
| Signₛₖ_{_{BE}}(data) | the original back-end signature on the sent transmission |
| {Uₙ} | An ordered set of the receiver units engaging in protocol. The v-th unit is denoted Uᵥ. |
| {Seqₜ}ᵥ* | The set of packet sequence numbers that the v-th unit is requesting (requests denoted by *). The t-th packet's sequence |
| | number is denoted Seqₜ. |
| {Seqₛ}_{w} | The set of packet sequence numbers that unit w is responding with. The s-th packet's sequence number is denoted Seqₛ. |

A requirement is that {Seqₛ}_{w}⊆{Seqₜ}*ᵥ. Namely, the set of sequence numbers that the w-th unit answers a request with must be a subset of the request.

Throughout this disclosure, the term packet refers to a section of the overall Update message M from the back-end, i.e., the message is divided into packets Mₙ for transmission, where Mₙ corresponds to a given Seqₙ and M₁//M₂// . . . /Mₙ// . . . =M represents the full Update transmission.

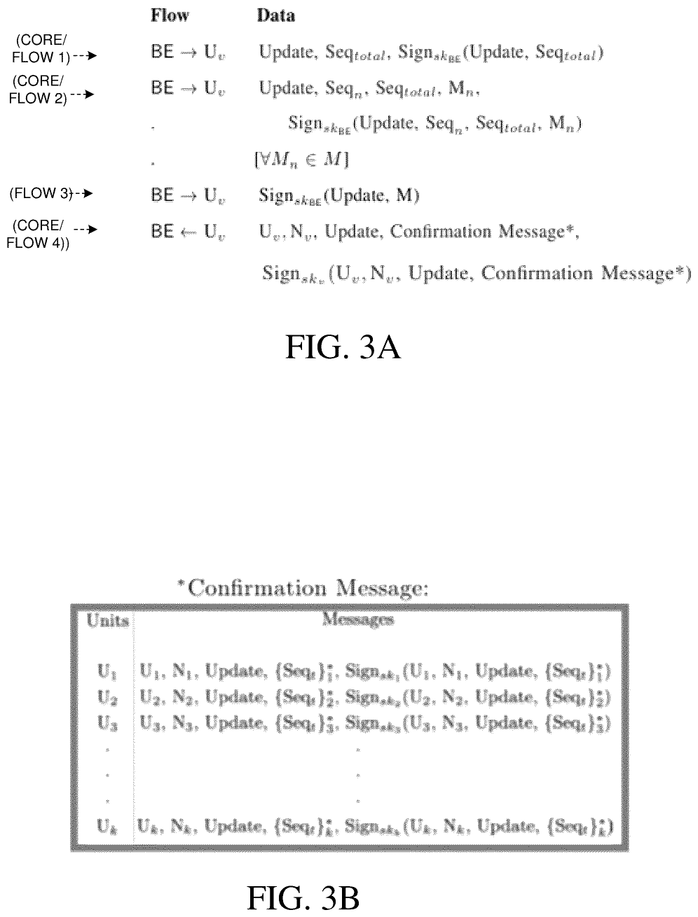

BAC Protocol (FIGS. 3A and 3B)

Protocol Description: The overarching flow of the BAC protocol consists of the back-end server sending an “announcement message” followed by the update message itself in iterative packets (each individually signed), and finally a signature over the complete Update message. Ideally, the back-end would provide the entire sender side of the protocol (FIG. 3A. Flows 1-3) on repeat to reduce the number of packets missing from the receiving units' transcripts. This is due to the use case environment, where dropped packets are likely with a transmission of the typical size; however, protocol repetition may not always be feasible given bandwidth constraints and is left as an application decision.

The protocol iteration is complete when the back-end (BE) receives a signed confirmation message from one of the units. The confirmation message is a compilation of requests from each of the receiver units, indicating what packets need to be re-transmitted. (If the confirmation message indicates missing packets, the implementation may select to restart the protocol sending only those packets, e.g., re-transmission of missing packets.)

The confirmation message is then signed by one of the receiver units and sent to the back-end. Although the message is signed and sent by only one unit, it is representative of all the receiver participants, so while the transmissions BE→Uᵥ are broadcast from the back-end to all participants, the transmission BE←Uᵥ is from one unit to the back-end.

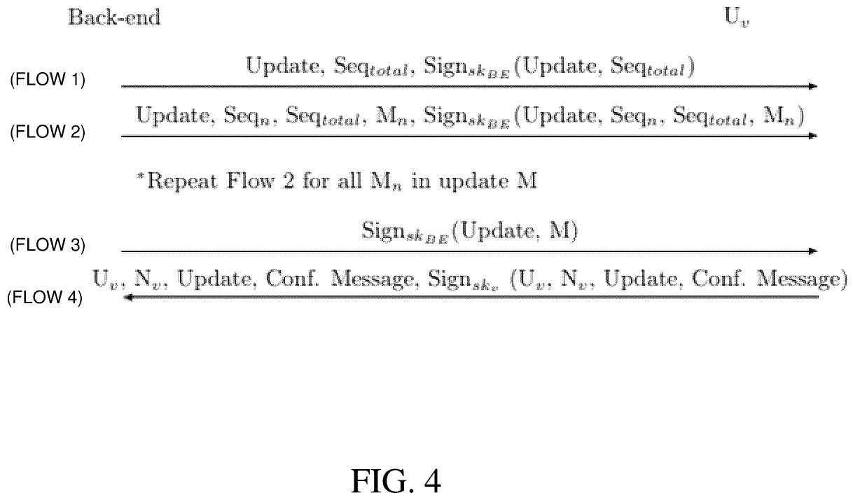

FIGS. 3A and 3B shows the BAC protocol (FIGS. 3A and 3B) in algorithmic form, with a visualization as shown in FIG. 4.

The protocol flows identified as CORE indicate the core BAC protocol. This protocol denotes agreement on possession of Update data packets and intent to send. The protocol on the receiver side, Uᵥ, ‘accepts’ as a correct run of the protocol if at least one of the CORE messages is received. The third Flow, Sign_{skBE}(Update, M), is a confirmation message on the sent Update message, for use later by receiver units, e.g., in COCO-SYNC-P or COCO-SYNC-R, as a verification to hold in memory over the entire Update message vice individual packets and can therefore be transferred and validated locally as needed. However, this last message from the back-end is not a protocol confirmation message and is therefore treated as channel data. Note also, that unless all other Flows from the BE are received, the Flow Sign_{skBE}(Update, M) cannot be validated; since packet dropping is intentionally supported and a confirmation message to request missing update packets is used, this third Flow is not considered part of the core protocol.

There is a space trade-off for including Seqₜₒₜₐₗ in each message instead of only in the first message. For a more robust protocol, it should be included as it enables the receiver units to verify the completeness of a received transmission even if the first and last packets are dropped. However, if the added space requirement is too much of a constraint, the Seqₜₒₜₐₗ can be omitted from data messages and only kept in the header message. In this scenario, units can verify the completeness of the data if they receive either the header or the final message; in absence of both and without the inclusion of Seqₜₒₜₐₗ, the receiver must await a re-transmission before verifying completeness.

Cache Requirements

It is expected that the receiver units will maintain a cache of the signatures (Sign_{skBE}(Update, M)) received in the transmission. This is essential for local distribution so that receiver units may verify the authenticity of the entire update message once received.

Furthermore, they may hold sequence numbers, packet numbers, and packets in memory for the duration of the COCO-SYNC protocol (Seqₙ, Seqₜₒₜₐₗ, Mₙ). Note, however, that due to optimization of bandwidth and transmission reliability, units may re-package the update into smaller packets before forwarding in the consensus protocol(s) among receivers. While allowing flexibility, this may incur a higher bandwidth cost locally, since receivers may only verify the update using Sign_{skBE}(Update, M) once the entire update is received. In the following COCO-SYNC protocol descriptions, the aim is to minimize protocol Flows and therefore support LPB/RF limitations by leveraging the assumption that sequence numbers, packet numbers, and packets are held in memory for local distribution during the COCO-SYNC protocol, i.e., Seqₙ, Seqₜₒₜₐₗ, Mₙ.

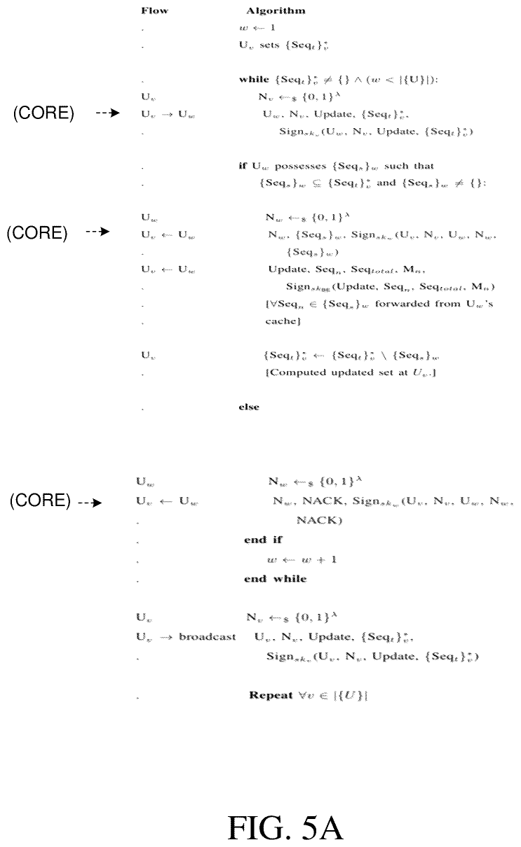

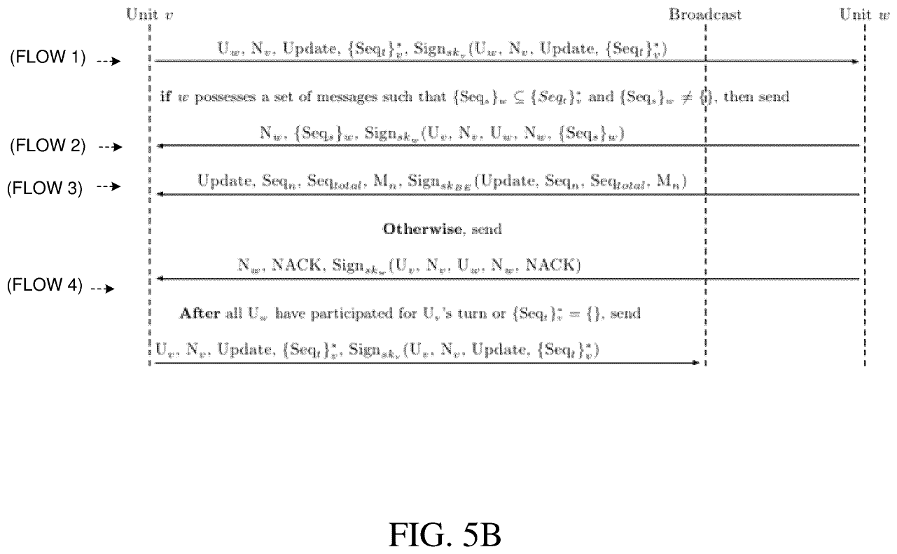

### COCO-SYNC-R (FIGS. 5A and 5B)

In both of the following COCO-SYNC protocol descriptions, the protocol is presented and described as an algorithm first, followed by a simplified Flow diagram as an illustration. This is done to demonstrate how w is iterated in the hierarchy throughout the protocol and explicitly show how variables are updated during the protocol. The Flow diagram simplifies the protocol representation to show only the protocol Flows-variable assignments are not shown in the Flow diagram, but assumed is that all of the variables are assigned according to the algorithmic description.

Protocol Description: The following description assumes there is an execution hierarchy ordering among the units which is known by all units. Unit v is selected from the top of the hierarchy and then removed from the hierarchy for the duration of its turn. For v's turn, unit w begins at the new top of the hierarchy and is iterated through all units in the ordering (excluding v). After v completes its turn, it is added back into the hierarchy ordering at the bottom and a new target unit is selected from the top of the ordering. This approaches enforces a queued hierarchy. Protocol COCO-SYNC-R is shown in FIG. 5A, with an illustration provided in FIG. 5B.

Protocol Flow's identified as CORE indicate the core COCO-SYNC-R protocol. This protocol denotes agreement on possession of Update data packets and intent to send. The actual messages of the Update are not included within the core protocol, as those may be dropped (leading to a break in protocol transcript matching.) Also, the final broadcast message is not included; the final broadcast message is collected for return as a confirmation message component in the BAC protocol (non-critical), rather than a critical aspect of the COCO-SYNC-R protocol. Furthermore, neither the BAC nor the COCO-SYNC-R protocol should not fail if this message is lost due to packet dropping. If Uᵥ's confirmation message is lost, there is no guarantee to the back-end that Uᵥ has the Update, but if other units possess the full Update it suffices that Uᵥ may obtain it from them. Otherwise, the lack of a full Update possessed by any unit in the BAC confirmation message indicates to the back-end possible need to re-transmit.

In addition to the above core protocol description, the implementation can include a fail-safe timeout. A timeout is crucial for added robustness by ensuring the protocol does not hang while waiting for a unit that loses connectivity or gets jammed. The timeout can be maintained by Uᵥ, and if no response from the current U_{w} is received within the timeout window, then a next U_{w} is selected and Uᵥ sends its request. It is beneficial, however, for Uᵥ to continue listening for a late response from a previous U_{w} so that broadcasts (if answered later) are not wasted due to a timeout.

Although the Flows indicate intended partners, the data can be sent in broadcast form, so all units will be able to listen for any transmissions containing missing sequence numbers even if that unit is not acting as v. The goal of this is to reduce the number of duplicate requests.

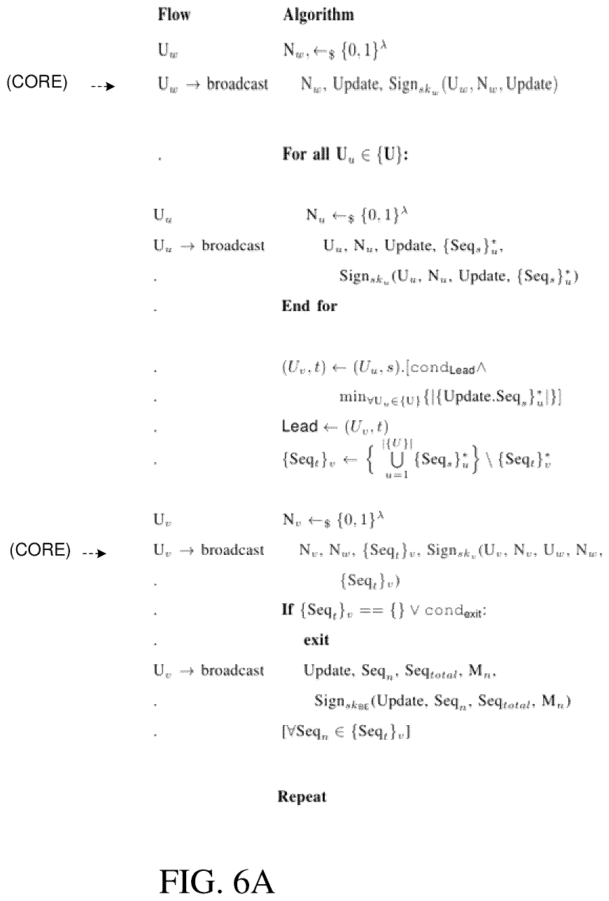

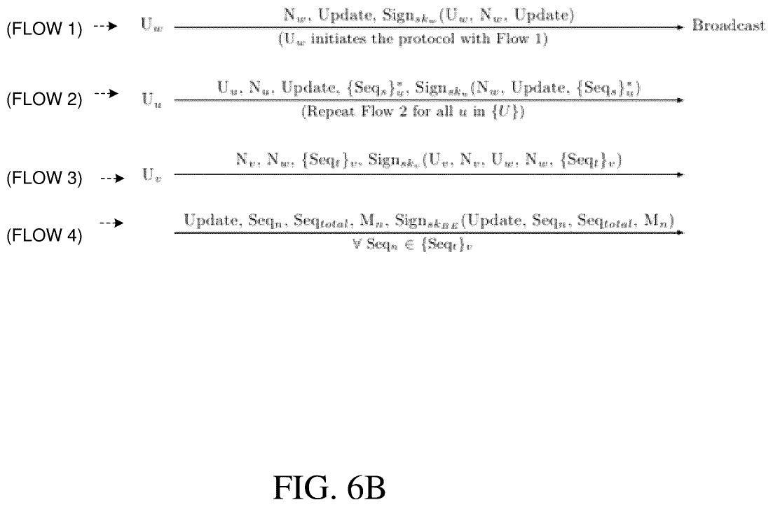

COCO-SYNC-P (FIGS. 6A and 6B)

Protocol Description: The following protocol reverses the approach of COCO-SYNC-R. Instead of each unit requesting what it needs from every other unit, all units will broadcast what they are missing at the beginning. Then, the unit with the most complete transcript will be selected as the lead unit and broadcast the missing sequence numbers it has to the other units. The protocol is designed to be iterative, and the protocol can be repeated until matching transcripts are achieved among all units, or an exit condition is set. With reference to FIG. 6A, process Flows identified as CORE are core COCO-SYNC-P protocol Flows and follow that of BAC and COCO-SYNC-R protocol. FIG. 6B provides an illustration of COCO-SYNC-P.

The protocol can be re-run (i.e., corresponding to Repeat), until all units' transcripts match or until predetermined number of iterations are reached. The former case is captured by {Seqₜ}ᵥ=={ } which holds if the request sets from all units were identical (whether from obtaining the full Update, partial but identical packet sets, or no update packets). In the worst case, units will have received the BAC message indicating that an Update would be set, but none of the ensuing Update packets. Protocol exit after a certain number of iterations can be enforced via condₑₓᵢₜ.

Allowed is a tie-breaker condition cond_{Lead}, such that if more than one unit has an equal number of minimum requested packets. Alternatively, if (Uᵤ, s) has already been the Lead, the condition can force a recalibration of hierarchy. For simplicity, cond_{Lead}=1 for the remainder of this disclosure but leave it up to the implementation for appropriate conditions to handle other such cases.

If packet drops occur when units are broadcasting their request sets, it is possible that more than one unit may claim the role as Lead. To account for this, a timeout can be enforced following Flow 3 where a unit broadcasts intent to be Lead. The timeout will allow all units that may have claimed lead to examine the other broadcast commit sets and cede the role of Lead to the unit with the most complete commit set. In the instance of more than one unit having commit sets of the same size, the role of Lead will go to the unit highest in the hierarchy.

In summary, described are three protocols for use in LPB/RF constrained scenarios: the BAC protocol which provides a means for a remote back-end to provide an update to receiver units while minimizing the amount of data that is sent, the COCO-SYNC-R protocol which allows receiver units to reach consensus on update data among themselves via a pull method, and COCO-SYNC-P which utilizes a push approach for inter-unit sharing and consensus. These protocols detail a robust method for providing software updates to space satellites and remote devices, applicable also to other data transfer, and provide receiver consensus options dependent on developer choice.

### 2. Remote Locations Communications System

According to another aspect of this disclosure, described now is an application of the three protocols previously described for delivering large data payloads to remote locations that minimizes radio frequency (RF) signature for receivers, thereby reducing the associated geolocation potential. The disclosed three cryptographic protocols are used for different components of a delivery architecture for a large data payload from a trusted, back-end source to receivers: a low-response protocol for initial transmission and confirmation and two possible inter-unit distribution protocols with differing optimizations based on connectivity scenarios. All three protocols expressly aim to minimize the radio frequency (RF) footprint created on the receiver end. These protocols introduce a means for accounting for both security (authentication) and safety (minimized RF footprint) in the delivery of critical data payloads to remote receivers.

Maintaining communications with extended forward units among military advanced base operations is vital to the success of the future mission, even when such forward units are separated for extended periods from the headquarters location. With the emphasis on communications, comes the critical task of sending software updates to forward units. While forces could rely on returning to headquarters for updates in the past, distributed operations will not have that luxury. Moreover, the radio frequency (RF) footprint of any network traffic sent by the forward units could risk compromising their positions. Therefore, it is necessary to be able to push updates securely and reliably to subordinate units while minimizing forward network traffic.

In the context of authentication in file-transfer protocols, there are particular demands in this environment for protocols which minimize the length and frequency of required responses. They must be designed for a back-end device or unit (‘unit’) that sends updates to receiver units. The back-end in this scenario acts as the original sender. An assumption here is that the back-end has extensive communications equipment, including sufficient power available for sending large messages (e.g., software updates). An update message may be sent to multiple units (e.g. various LEO satellites, various GEO satellites, various ground users in the same operational area). Such receiving units must receive the update transmission, determine any missing packets, obtain any missing packets from other receivers or request from the back-end if needed, and apply the update. As a special concern of this disclosure, receiver units may operate under Low Power/Bandwidth (LPB) or RF constraints. The goals of an appropriate authenticated file-transfer protocol are to authenticate the sender and minimize the power costs for the receivers.

Situation: Within the advanced base operations construct, a protocol must be designed for a headquarters (back-end) unit that sends updates to operating units. The back-end in this scenario acts as the original sender. For purposes of this disclosure, it is assumed that the back-end's RF footprint is not a concern (e.g., that the back-end is geolocated in a stable position). The goal of the back-end is to push update messages to all receiving units via satellite communications (SATCOM). An update message will be broadcast to multiple units in the same operational area. Receiving units receives the update message via multiple packets or a subset of the full update (in the case of semi-denied transmission), must validate the packets and determine any missing packets within the full update message, confer internally to get obtain any missing packets possible from other forward units, and apply the update or request missing packets from the back-end.

Constraints: The main constraint in this problem is the necessity for a low RF signature on the receiving end. Given the dynamic adversarial threat, the receiving units do not have the luxury of communicating with the sender extensively. Any amount of RF footprint emitted by the receiving unit can expose their location to the enemy, and the degree of RF emitted may vary depending on local communication or SATCOM communication needs. Conventionally, RF concerns are a physical layer issue, and work solving them has focused solely in that area; however, as a transport, the physical layer RF footprint is induced by the amount of higher layer traffic that is required. According to this disclosure and the protocols previously described, it is demonstrated how higher layer protocols can be selected to reduce the volume of necessary transmissions from the receivers, consequently reducing RF.

In addition to reducing RF footprint, the protocol must provide security against data modification, e.g., if an adversary tried to provide a malicious payload to the forward units. Furthermore, if the adversary was able to trick forward units into sending unnecessary responses, e.g., through impersonation of the back-end, the adversary could achieve RF geolocation of the units. Thus, the essential goals of such low-RF authentication protocols are to authenticate the back-end and any communicating parties, while minimizing the RF footprint for forward receivers.

As previously discussed, updating software is not a new concept, neither in the military nor in the civilian world. However, based on the new constraints and warfare environment defined above, some military applications or extremely secure applications cannot rely on the previous means it used to update software. Furthermore, in contrast to normal software updating in commercial sectors, for some military applications or extremely secure applications, any radio frequency (RF) footprint generation due to bi-directional traffic poses and immediate and significant risk to operating units. Thus, standard paradigms based on bi-directional client-server communications may not be feasible.

Military equipment is not the only area experiencing this problem. Industrial automation and control systems are experiencing a similar threat, with adversarial attack capabilities increasing in effectiveness against older equipment, which normally includes a process for installing patches and updates which includes significant testing of the update and distribution through a standardized structure in accordance with a defined policy, and is focused on policy and management but is designed for a situation with few unknown variables. The number of machines is known, the location of all machines is known and static, the activity of machines should be the same, and the RF signature is not of concern.

Conversely, this disclosure addresses a scenario which is dynamic with many unknowns, and the back-end may not have knowledge of the state of the update recipients. For example, the number and location of units may vary, the activities of units may vary, and—crucially—the RF signature is a concern. This precludes the described industrial solution as a solution for the considered context.

Various prior works have addressed methods and policies of updating military equipment, authentication mechanisms for providing authenticity of updates within supply chains, and techniques for updating firmware on remote embedded devices. Peer-to-peer (P2P) file sharing for Internet-of-Things networks has also been explored in the InterPlanetary File System (IPFS), as a means to share information among dispersed nodes, with file versioning and enable weblike sharing. However, all of these methods rely on heavy interaction between devices or nodes, which would lead to a high RF signature footprint and geolocation risk for end devices.

Provided herein is a new software update protocol, comprised of the three sub-protocols previously described (a low-response protocol for initial transmission and confirmation (BAC protocol), and two possible inter-unit distribution protocols (COCO-SYNC-R protocol (Pull) or COCO-SYNC-P (PUSH)) that securely deliver an update to a group of participants while minimizing the RF signature of the participants.

Specifically, the update protocol includes:
1) Back-haul Authenticated Control (BAC): An update protocol providing authenticated messages from a back-end to receiver participants as well as a push-button option for selective confirmation response on the received message.
2) Constrained Communication Synchronization-Request (COCO-SYNC-R): An inter-unit packet sharing protocol for distribution and confirmation of receipt of the update amongst forward participants. This protocol utilizes a pull method for sharing packets.
3) Constrained Communication Synchronization-Provide (COCO-SYNC-P): An inter-unit packet sharing protocol for distribution and confirmation of receipt of the update amongst forward participants. This protocol utilizes a push method where one unit broadcasts to all other units.

Mathematical bounds for the RF signature footprint on the above protocols is also provided herein.

Protocols

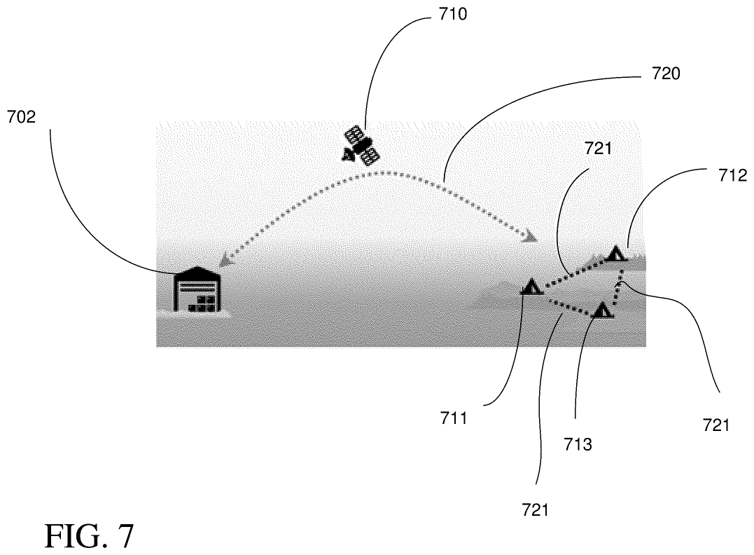

While the protocols described below are essentially the same as previously described, they are provided again, in part, to describe an application to a remote locations communication system. The first, Back-haul Authenticated Control (BAC) protocol, governs the authenticated data transfer from the back-end to the forward units. The other two protocols are alternatives that govern inter-unit communication for data sharing among the units. First, described is the Constrained Communication Synchronization-Request (COCO-SYNC-R) protocol, which utilizes a “pull” mechanism. Second, described is a “push” mechanism alternative protocol, Constrained Communication Synchronization-Provide (COCO-SYNC-P). These protocol roles are illustrated in FIG. 7 (720: Back-end to the forward units BAC Protocol; 721: inter-unit communication for data sharing among the units COCO-SYNC-R or COCO-SYNC-P protocol), where a satellite communication system includes a back-end unit(s) 702, one or more satellites or other remote distribution channels or relays 710 and one or more mobile receiving units 711, 712 and 713.

Since the primary concern is with authentication from the back-end for the update, used are asymmetric digital signatures. Encryption is not provided within the protocol, but it should be noted that in practice, military units use equipment with built in encryption methods. According to one equipment example, used is AES-256 bit symmetric encryption and pre-shared Transmission Encryption Keys (TEK). This encryption method provides protection from adversaries listening in (confidentiality), but it does not provide a means to verify the identity of a sender (authenticity) nor uniqueness of the transmission (replay protection). Symmetric encryption requires additional computational resources from the equipment, but it does not significantly impact the RF signature from the forward units. In the worst case, the encryption will require an additional 255-bits per transmission. Assuming a Max Transmission Unit of 1500 Bytes (12,000 bits), the encryption will only incur a 2% increase in RF.

In the protocols, Flows that contain a digital signature do not necessarily include an identity certificate from the sender. The protocol assumes that the receiver will have a list of public keys, including the back-end and forward units, and will perform an exhaustive search on this list until it finds a key that verifies the tag (with the exception of confirmation messages which attest to the sender). While this is an additional computational cost, it allows us to reduce the RF bandwidth, so the added computation is acceptable. Additionally, the public key list maintained by the forward units will be relatively small (<1000) so the added time to compute in practice will be negligible. Note, however, that this search can be avoided by the protocol implementors by inclusion of a sender identity, if desired.

### Variables:

BE: Back-end Sender
Uᵥ: Receiver
k: The number of forward units participating in the protocol
Nᵥ: A fresh nonce sampled by Uᵥ, where Nᵥ∈{1, 0}*
Updated: Numeric identifier for x-th update. This may also be interpreted as Seq Update. We abuse notation and simply use Update, with the sequencing of further updates handled by the application.
M: Complete update message for the transmission
Mₙ: The n-th packet of the update message
Seqₙ: Numeric sequence number for the n-th packet. This may also be interpreted as Seq Packetₙ.
Seqₜₒₜₐₗ: Total number of packets included in transmission

### Notation:

Signₛk_{BE}(data): the tag generated from signing data with BE's secret key
BE→Uᵥ: sending of data from BE to Uv

BAC Protocol (FIG. 3A and FIG. 3B)

Protocol Description: The overarching flow of the BAC protocol consists of the back-end server sending an “announcement message” followed by the update message itself in iterative packets (each individually signed), and finally a signature over the complete update message. Ideally, the back-end would provide the entire sender side of the protocol (Flow 1-3) on repeat to reduce the number of packets missing from the receiving units' transcripts. This is due to the use environment, where dropped packets are likely with a transmission of the typical size; however, protocol repetition may not always be feasible given bandwidth constraints and is left as an application decision.

The protocol iteration is complete when the back-end (BE) receives a signed confirmation message from one of the units. There is no time constraint on when the confirmation message may be sent. The confirmation message is a compilation of requests from each of the forward units, indicating what packets need to be re-transmitted. (If the confirmation message indicates missing packets, the implementation may select to restart the protocol sending only those packets, e.g., re-transmission of missing packets.) The confirmation message is then signed by one of the forward units and sent to the back-end. Although the message is signed and sent by only one unit, it is representative of all the receiver participants, so while the transmissions BE→Uᵥ are broadcast from the back-end to all forward participants, the transmission BE←Uᵥ is from one unit to the back-end.

Cache Requirements

It is expected that the forward units will maintain a cache of the signatures (Sign_{skBE} (Update, M)) received in the transmission. This is essential for local distribution so that receiver units may verify the authenticity of the entire update message once received.

Furthermore, they may hold sequence numbers, packet numbers, and packets in memory for the duration of the COCO-SYNC protocol (Seqₙ, Seqₜₒₜₐₗ, Mₙ). Note, however, that due to optimization of bandwidth and transmission reliability, units may re-package the update into smaller packets. While allowing flexibility, this may increase RF footprint locally, since receivers may only verify the update using Sign_{skBE} (Update, M) once the entire update is received. In the following COCO-SYNC protocol descriptions, the aim is to minimize protocol flows and therefore RF footprint by leveraging the assumption that sequence numbers, packet numbers, and packets are held in memory for local distribution during the COCO-SYNC protocol, i.e., Seqₙ, Seqₜₒₜₐₗ, Mₙ.

COCO-SYNC-R (FIG. 5A and FIG. 5B)

In both of the COCO-SYNC protocols, the protocol is described as an algorithm first, followed by a simplified flow diagram as illustration. This is done to demonstrate how w is iterated in the hierarchy throughout the protocol and explicitly show how variables are updated during the protocol. The flow diagram simplifies the protocol representation to show only the protocol flows—variable assignments are not shown in the flow diagram, but it is assumed that all of the variables are assigned according to the algorithmic description.

Variables: In addition to the variables listed previously, we add the following notation:
{Uᵥ}: An ordered set of the forward units engaging in protocol. The v-th unit is denoted Uᵥ.
{Seqₜ}*ᵥ: The set of packet sequence numbers that the v-th unit is requesting (requests denoted by *). The t-th packet's sequence number is denoted Seqₜ.
{Seqₛ}_{w}: The set of packet sequence numbers that unit w is responding with. The s-th packet's sequence number is denoted Seqₛ.

A requirement is that {Seqₛ}_{w}⊆{Seqₜ}*ᵥ. Namely, the set of sequence numbers that the w-th unit answers a request with must be a subset of the request.

Protocol Description: The following description assumes there is an execution hierarchy ordering among the units which is known by all units. (See FIG. 5A.) Unit v is selected from the top of the hierarchy and then removed from the hierarchy for the duration of its turn. For v's turn, unit w begins at the new top of the hierarchy and is iterated through all units in the ordering (excluding v). After v completes its turn, it is added back into the hierarchy ordering at the bottom and a new target unit is selected from the top of the ordering. This approaches enforces a queued hierarchy.

The implementation can include a fail-safe timeout. A timeout is crucial for added robustness to the protocol by ensuring the protocol does not hang while waiting for a unit that loses connectivity or gets jammed. The timeout can be maintained by Uᵥ, and if no response from the current U_{w} is received within the timeout window, then a next U_{w} is selected and Uᵥ sends its request. It would be beneficial, however, for Uᵥ to continue listening for a late response from a previous U_{w} so that RF broadcasts (if answered later) are not wasted just because of the timeout.

Although the flows indicate intended partners for authentication of possession, the data will be sent in broadcast form, so all units will be able to listen for any transmissions containing missing sequence numbers even if that unit is not acting as v. The goal of this is to reduce the number of duplicate requests.

COCO-SYNC-P (FIGS. 6A and 6B)

Protocol Description: The following protocol (See FIG. 6A) reverses the approach of COCO-SYNC-R. Instead of having each unit request what it needs from every other unit, all units will broadcast what they are missing at the beginning. Then, the unit with the most complete transcript will be selected as the lead unit and broadcast the missing sequence numbers it has to the other units. The protocol is designed to be iterative, and the protocol can be repeated until matching transcripts are achieved among all units, or an exit condition is set.

The protocol can be re-run (i.e., corresponding to Repeat), until all units' transcripts match or until predetermined number of iterations are reached. The former case is captured by {Seqₜ}ᵥ=={ } which holds if the request sets from all units were identical (whether from obtaining the full update, partial but identical packet sets, or no update packets). In the worst case, units will have received the BAC message indicating that an update would be set, but none of the ensuing update packets. Protocol exit after a certain number of iterations can be enforced via condₑₓᵢₜ.

A tie-breaker condition cond_{Lead} is allowed, such that if more than one unit has an equal number of minimum requested packets. Alternatively, if (Uᵤ, s) has already been the Lead, the condition can force a re-calibration of hierarchy. For simplicity, cond_{Lead}=1 for the remainder of this description but leave it up to the implementation for appropriate conditions to handle other such cases.

If packet drops occur when units are broadcasting request sets, it is possible that more than one unit may claim the role as Lead. To account for this, a timeout can be enforced following Flow 3 (intent to broadcast). The timeout will allow all units that may have claimed lead to examine the other broadcast commit sets and cede the role of the Lead unit to the unit the most complete commit set. In the instance of more than one unit having commit sets of the same size, the role of Lead will go to the unit highest in the hierarchy.

One benefit to COCO-SYNC-P is that it only highlights the RF signature of the lead unit. Thus, if one unit is in a position where it is safer to broadcast RF, that unit could always be selected as the lead (Uᵥ). Additionally, the protocol can be adapted to add a step where the lead unit requests missing sequence numbers from units it knows has them based on the initial request broadcasts. That way, the lead unit has the most complete transcript possible before it broadcasts.

### RF Analysis

Provided now is an analysis of the RF footprint of the three protocols presented in this disclosure. For each protocol, a worst-case analysis is performed of the RF footprint under a correct protocol run, i.e., the most expensive run of the protocol where the protocol still terminates, and there has been no adversarial interference. If an adversary were to e.g., drop packets through jamming, it could force the protocol to loop or restart, hence considered are such instances outside of the RF baseline analysis. It is important to note that the average cases for these protocols will have a significantly lower RF footprint than the worst case; the upper bounds simply represent the maximum footprint possible. Also provided is a best case analysis.

It is assumed that the inter-unit communications are less RF-expensive than SATCOM communications to the back-end. Using this assumption, the analysis is performed by calculating the RF cost per transmission as the product of power level and message length, represented as

RF=(PowerLevel)·(|message|).

Inter-unit transmissions will be considered low power, while transmissions to the backend will be considered high power.

Variables: In addition to the variables used for the protocols described above, the following notation is added:
k: Number of forward units participating in the protocol.
P_{L}/P_{H}: RF footprint associated with low power (resp. high power) RF transmission.
v: The field bit-length allotted for entity identifiers, Uᵥ∈ [symbol]
μ: The field bit-length allotted for a sequence number, i.e., |Seqₙ|. We assume that the field length allotted for the back-end sequence number (i.e., the sequence number Update), the nonce field length, and the NACK length are equivalent to the field length allotted for packet sequence numbers, i.e., μ=|Seqₙ|≈|Update|≈|Nᵥ|≈|NACK|.
ρ: The length in bits of the signature tag generated from signing a message.
ω: The length in bits of the update message M, i.e., Seqₜₒₜₐₗ·|Mₙ|=ω.

The analysis can be adjusted accordingly for cases where |Seqₙ|≈|Update|≈|Nᵥ| does not hold. For simplicity we assume that v≤μ.

BAC—Worst Case

The worst case scenario for the BAC protocol occurs if the back-end transmits the update and none of the units receive any part of the update. In this case, one unit will reply with a confirmation message that indicates that all units are missing all packets.

The example worst-case RF footprint of the forward units is calculated as:

$${RF}_{BAC} \leq {P}_{H} \cdot ( \vert {U}_{υ} \vert + \vert {N}_{υ} \vert + \vert Update \vert + k ( \vert {U}_{υ} \vert + \vert {N}_{υ} \vert + {Seq}_{total} \cdot \vert Seq \vert + \vert sig \vert ) + \vert sig \vert ) \leq {P}_{H} \cdot ( ( k + 1 ) ( v + ρ ) + μ ( k + k {Seq}_{total} + 2 ) ) .$$

BAC—Best Case

Now, the best case RF footprint for BAC is calculated. This corresponds to when all packets are correctly received the back-end transmission.

$${RF}_{BAC} \leq {P}_{H} \cdot ( \vert {U}_{υ} \vert + \vert {N}_{υ} \vert + \vert Update \vert + k ( \vert {U}_{υ} \vert + \vert {N}_{υ} \vert + \vert Seq \vert + \vert sig \vert ) + \vert sig \vert ) \leq {P}_{H} \cdot ( k + 1 ) ( v + 2 μ + ρ )$$

COCO-SYNC-R—Worst Case.

For the COCO-SYNC-R protocol, the worst-case RF footprint occurs if no unit received the full Update message, thus necessitating each requester to contact every other unit. Simultaneously, this occurs when the units cumulatively possess the full Update message, as otherwise less packets exist to share. In this scenario, each unit, when acting as Uᵥ, must make a request to all other units and will receive the full Update message. In the worst case scenario, Uᵥ only obtains the full Update message after sending requests to all other units—without loss of generality we simplify representation of this case by having κ−1 units missing Seqₜₒₜₐₗ−1 packets, while the last unit is missing 1 packet.

$${RF}_{SYNC - R} \leq {P}_{L} \cdot ( ( k - 1 ) \cdot ( \vert {U}_{ω} \vert + \vert {N}_{υ} \vert + \vert Update \vert + ( {Seq}_{total} - 1 ) \cdot \vert Seq \vert + \vert sig \vert ) + ( k - 2 ) \cdot ( \vert {N}_{ω} \vert + \vert NACK \vert + \vert sig \vert ) + ( \vert {N}_{ω} \vert + ( {Seq}_{total} - 1 ) \cdot \vert Seq \vert + \vert sig \vert ) + ( {Seq}_{total} - 1 ) \cdot ( \vert Update \vert + \vert Seq \vert + \vert Seq \vert + \vert {M}_{n} \vert + \vert sig \vert ) + ( \vert {U}_{ω} \vert + \vert {N}_{υ} \vert + \vert Update \vert + \vert Seq \vert + \vert sig \vert ) + ( \vert {N}_{ω} \vert + \vert Seq \vert + \vert sig \vert ) + ( \vert Update \vert + \vert Seq \vert + \vert Seq \vert + \vert {M}_{n} \vert + \vert sig \vert ) + k ( \vert {U}_{υ} \vert + \vert {N}_{υ} \vert + \vert Update \vert + \vert Seq \vert + \vert sig \vert ) ) \leq {P}_{L} \cdot ( k υ + 7 k μ + k μ {Seq}_{total} + 2 k ρ + 4 ρ + 3 μ {Seq}_{total} + ρ {Seq}_{total} + ω )$$

COCO-SYNC-R—Best Case

The best-case scenario occurs when all units have correctly received the full Update transmission and share confirmation of that inter-unit.

$${RF}_{SYNC - R} \leq {P}_{L} \cdot k ( \vert {U}_{υ} \vert \vert {⋃}_{u , s} {\{ {Seq}_{s} \}}_{u} \vert = {Seq}_{total} \vert seq \vert + \vert sig \vert ) \leq {P}_{L} \cdot k ( v + 3 μ + ρ )$$

COCO-SYNC-P—Worst Case

The worst case for the COCO-SYNC-P protocol (run until matching transcripts among the receivers are achieved) occurs if no one unit received all Update packets from the initial BAC transmission. In this scenario, the maximum number of messages

$$\vert {⋃}_{u , s} {\{ {Seq}_{s} \}}_{u} \vert = {Seq}_{total} .$$

would need to be transmitted. Without loss of generality, it is supposed that each unit has received non-empty set of packets {Seqₜ}ᵥ such that |{Seqₜ}ᵥ|=|{Seqₛ}ᵤ|=q for all u, s and {Seqₜ}ᵥ∩{Seqₛ}ᵤ=Ø. Thus

In this calculation, it is assumed that the protocol repeats until all units have broadcast their packets.

$${RF}_{SYNC - R} \leq {P}_{L} \cdot {\sum }_{i = 0} ( \vert {N}_{ω} \vert + \vert Update \vert + \vert sig \vert + ( \vert {U}_{ω} \vert + \vert {N}_{u} \vert + \vert Update \vert + \vert Seq \vert \cdot \vert {\{ Seq \}}_{u}^{s} \vert \cdot ( i ( k - 1 ) + ( k - i ) ( k - 1 - i ) ) + \vert sig \vert ) + \vert {N}_{υ} \vert + \vert {N}_{ω} \vert + \vert Seq \vert \cdot \vert {\{ Seq \}}_{υ} \vert + \vert sig \vert + \vert {\{ Seq \}}_{v} \vert \cdot ( \vert Update \vert + \vert Seq \vert + \vert {Seq}_{total} \vert + \vert {M}_{n} \vert + \vert sig \vert ) ) \leq {P}_{L} ( k v + 6 k μ + 2 k ρ + ρ + \frac{5}{2} μ {Seq}_{total} + ω + ρ Seq + ρ {Seq}_{total} + \frac{1}{2} {k}^{2} μ {Seq}_{total} + k μ {Seq}_{total} )$$

COCO-SYNC-P—Best Case.

As with COCO-SYNC-R, the best-case scenario for COCO-SYNC-P occurs when all units have correctly received the full Update transmission and share confirmation of that inter-unit.

$${RF}_{SYNC - P} \leq {P}_{L} \cdot ( \vert {N}_{ω} \vert + \vert Update \vert + \vert sig \vert + k ( \vert {U}_{υ} \vert + \vert {N}_{u} \vert + \vert Update \vert + \vert Seq \vert + \vert sig \vert ) ) \leq {P}_{L} \cdot ( 2 μ + ρ + k ( v + 3 μ + ρ ) )$$

Provided are three protocols for use in a constrained RF scenario: the BAC protocol which provides a means for a remote back-end to provide an update to forward units while minimizing the amount of data that is sent by the forward units over SATCOM, the COCO-SYNC-R protocol which allows units to share update data among themselves via a pull method, and COCO-SYNC-P which utilizes a push approach for inter-unit sharing. These protocols detail a robust method for updating EABO software (or sharing a mutual view of other information) and provide options to the end user on how to share packets amongst receivers.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A method for transferring a complete message from a back-end unit to a plurality of receiving units, the complete message including a plurality of interactive packets, each packet including a subsection of the complete message, the method comprising:
the back-end unit authenticating each of the interactive packets and generating authentication data for each of the interactive packets;
the back-end authenticating the complete message and generating authentication data for the complete message;
the back-end unit sending the complete message, including the iterative packet authentication data and the complete message authentication data, to a plurality of receiving units using at least one radio frequency (RF) link;
the back-end unit receiving a confirmation response from exactly one of the plurality of receiver units, wherein the confirmation response describes an updated status of each of the receiver units, the updated status of each of the receiver units includes a message indicating one or more of 1) the complete message was received by all receiver units, and 2) an identifier of the iterative packets not received by one or more receiving units; and
the back-end unit sending only the iterative packets not received by one or more of the receiver units,
wherein the plurality of receiver units includes at least one receiver unit which communicates with the other receiver units to acquire the update status of the sent complete message for each of the plurality of other receiver units and at least one receiver unit communicates the update status to the back-end sending unit.

2. The method of claim 1, wherein each of the plurality of receiver units maintains a cache of authentication data to authenticate the complete message received from the back-end unit and each of the iterative packets received from the back-end unit.

3. The method of claim 1, wherein each of the receiving units maintains a cache of local authenticated packets of the message.

4. The method of claim 1, wherein the plurality of receiving units communicate with each other using an inter-unit iterative packet sharing protocol for distribution of the iterative packets and confirmation of receipt of the complete message amongst the plurality of receiving units.

5. The method of claim 4, wherein the inter-unit iterative packet sharing protocol is one of a pull method for sharing iterative packets or a push method for sharing iterative packets.

6. The method of claim 5, wherein the inter-unit iterative packet sharing protocol is a pull method for sharing iterative packets, and the plurality of receiver units have an execution hierarchy including an ordered set of the plurality of receiver units, and wherein the method further comprises:
a top receiving unit sending a request for a set of missing iterative packets to one or more of the other receiving units of the execution hierarchy, wherein after receiving the request for the set of missing iterative packets, each of the other receiving units which have one or more of the missing iterative packets responds by sending the one or more of the missing iterative packets;
the units, including the top receiving unit receiving the sent one or more of the missing iterative packets;
queuing the top receiving to a bottom of the execution hierarchy; and
queuing the next receiving unit of the execution hierarchy to be the top receiving unit.

7. The method of claim 5, wherein the inter-unit iterative packet sharing protocol is a push method for sharing iterative packets, and wherein the method further comprises:
a) all the receiving units sending to the other receiving units a request for any missing iterative packets;
b) determining a receiving unit with the most complete set of iterative packets and designating the determined receiving unit as the lead receiving unit;
c) the lead receiving unit sending to the other receiving units one or more of the missing iterative packets; and
d) iteratively performing steps a)-c) until all receiving units have a complete message, all receiving units are missing identical iterative packets or a predetermined timeout period has expired.

8. The method of claim 5 wherein the inter-unit iterative packet sharing protocol is a push method for sharing iterative packets, the plurality of receiver units have an execution hierarchy including an ordered set of the plurality of receiver units, wherein the method further comprises:
a) all the receiving units sending to the other receiving units a request for any missing iterative packets;
b) a top receiving unit sending to the other receiving units requests for one or more top receiving unit missing iterative packets;
c) determining a receiving unit with the most complete set of iterative packets and designating the determined receiving unit as the lead receiving unit;
d) the lead receiving unit sending to the other receiving units one or more of the missing iterative packets; and
e) iteratively performing steps a)-d) until all receiving units have a complete message, all receiving units are missing identical iterative packets or a predetermined timeout period has expired.

9. A satellite communication system including a back-end unit, and a plurality satellites configured to communicate with the back-end unit, wherein the plurality of satellites each include a receiving unit and are configured to communicate with one or more of the other satellites, the satellite communication system performing a method for transferring a complete message from the back-end unit to at least one of the plurality of satellite receiving units, the complete message including a plurality of interactive packets, each packet including a subsection of the complete message, the method comprising:
the back-end unit authenticating each of the interactive packets and generating authentication data for each of the interactive packets;
the back-end authenticating the complete message and generating authentication data for the complete message;
the back-end unit sending the complete message, including the iterative packet authentication data and the complete message authentication data, to at least one of the plurality of the satellite receiving units using at least one radio frequency (RF) link;
the back-end unit receiving a confirmation response from exactly one of the plurality of the satellite receiver units, wherein the confirmation response describes an updated status of each of the satellite receiver units, the updated status of each of the satellite receiver units includes a message indicating one or more of 1) the complete message was received by all satellite receiver units, and 2) an identifier of the iterative packets not received by one or more satellite receiving units; and
the back-end unit sending only the iterative packets not received by one or more of the satellite receiver units,
wherein the plurality of satellite receiver units include at least one satellite receiver unit which communicates with the other satellite receiver units to acquire the update status of the sent complete message for each of the plurality of other satellite receiver units, and at least one satellite receiver communicates the update status to the back-end sending unit.

10. The system of claim 9, wherein each of the plurality of receiver units maintains a cache of authentication data to authenticate the complete message received from the back-end unit and each of the iterative packets received from the back-end unit.

11. The system of claim 9, wherein each of the receiving units maintains a cache of local authenticated packets of the message.

12. The system of claim 9, wherein the plurality of receiving units communicate with each other using an inter-unit iterative packet sharing protocol for distribution of the iterative packets and confirmation of receipt of the complete message amongst the plurality of receiving units.

13. The system of claim 12, wherein the inter-unit iterative packet sharing protocol is one of a pull method for sharing iterative packets or a push method for sharing iterative packets.

14. The system of claim 13, wherein the inter-unit iterative packet sharing protocol is a pull method for sharing iterative packets, and the plurality of receiver units have an execution hierarchy including an ordered set of the plurality of receiver units, and wherein the method further comprises:
a top receiving unit sending a request for a set of missing iterative packets to one or more of the other receiving units of the execution hierarchy, wherein after receiving the request for the set of missing iterative packets, each of the other receiving units which have one or more of the missing iterative packets responds by sending the one or more of the missing iterative packets;
the top receiving unit receiving the sent one or more of the missing iterative packets;
queuing the top receiving to a bottom of the execution hierarchy; and
queuing the next receiving unit of the execution hierarchy to be the top receiving unit.

15. The system of claim 13, wherein the inter-unit iterative packet sharing protocol is a push method for sharing iterative packets, and wherein the method further comprises:
a) all the receiving units sending to the other receiving units a request for any missing iterative packets;
b) determining a receiving unit with the most complete set of iterative packets and designating the determined receiving unit as the lead receiving unit;
c) the lead receiving unit sending to the other receiving units one or more of the missing iterative packets; and
d) iteratively performing steps a)-c) until all receiving units have a complete message, all receiving units are missing identical iterative packets or a predetermined timeout period has expired.

16. The system of claim 13 wherein the inter-unit iterative packet sharing protocol is a push method for sharing iterative packets, the plurality of receiver units have an execution hierarchy including an ordered set of the plurality of receiver units, wherein the method further comprises:
a) all the receiving units sending to the other receiving units a request for any missing iterative packets;
b) a top receiving unit sending to the other receiving units requests for one or more top receiving unit missing iterative packets;
c) determining a receiving unit with the most complete set of iterative packets and designating the determined receiving unit as the lead receiving unit;
d) the lead receiving unit sending to the other receiving units one or more of the missing iterative packets; and
e) iteratively performing steps a)-d) until all receiving units have a complete message, all receiving units are missing identical iterative packets or a predetermined timeout period has expired.

17. A satellite communication system including a back-end unit, a plurality of mobile receiving units, and a satellite configured to communicate with the back-end unit and communicate with one or more of the plurality of mobile receiving units, and wherein the plurality of mobile receiving units are configured to communicate with one or more of the other mobile receiving units, the satellite communication system performing a method for transferring a complete message from the back-end unit to the plurality of mobile receiving units, the complete message including a plurality of interactive packets, each packet including a subsection of the complete message, the method comprising:
the back-end unit authenticating each of the interactive packets and generating authentication data for each of the interactive packets;
the back-end authenticating the complete message and generating authentication data for the complete message;
the back-end unit and satellite sending the complete message, including the iterative packet authentication data and the complete message authentication data, to a plurality of the mobile receiving units using at least one radio frequency (RF) link;
the back-end unit receiving a confirmation response from exactly one of the plurality of the mobile receiver units, wherein the confirmation response describes an updated status of each of the mobile receiver units, the updated status of each of the mobile receiver units includes a message indicating one or more of 1) the complete message was received by all mobile receiver units, and 2) an identifier of the iterative packets not received by one or more mobile receiving units; and
the back-end unit sending only the iterative packets not received by one or more of the mobile receiver units,
wherein the plurality of mobile receiver units includes at least one mobile receiver unit which communicates with the other mobile receiver units to acquire the update status of the sent complete message for each of the plurality of other mobile receiver units, and at least one mobile receiver communicates the update status to the back-end sending unit.

18. The system of claim 17, wherein each of the plurality of receiver units maintains a cache of authentication data to authenticate the complete message received from the back-end unit and each of the iterative packets received from the back-end unit.

19. The system of claim 17, wherein each of the receiving units maintains a cache of local authenticated packets of the message.

20. The system of claim 17, wherein the plurality of receiving units communicate with each other using an inter-unit iterative packet sharing protocol for distribution of the iterative packets and confirmation of receipt of the complete message amongst the plurality of receiving units.

21. The system of claim 20, wherein the inter-unit iterative packet sharing protocol is one of a pull method for sharing iterative packets or a push method for sharing iterative packets.

22. The system of claim 21, wherein the inter-unit iterative packet sharing protocol is a pull method for sharing iterative packets, and the plurality of receiver units have an execution hierarchy including an ordered set of the plurality of receiver units, and wherein the method further comprises:
a top receiving unit sending a request for a set of missing iterative packets to one or more of the other receiving units of the execution hierarchy, wherein after receiving the request for the set of missing iterative packets, each of the other receiving units which have one or more of the missing iterative packets responds by sending the one or more of the missing iterative packets;
the top receiving unit receiving the sent one or more of the missing iterative packets;
queuing the top receiving to a bottom of the execution hierarchy; and
queuing the next receiving unit of the execution hierarchy to be the top receiving unit.

23. The system of claim 21, wherein the inter-unit iterative packet sharing protocol is a push method for sharing iterative packets, and wherein the method further comprises:
a) all the receiving units sending to the other receiving units a request for any missing iterative packets;
b) determining a receiving unit with the most complete set of iterative packets and designating the determined receiving unit as the lead receiving unit;
c) the lead receiving unit sending to the other receiving units one or more of the missing iterative packets; and
d) iteratively performing steps a)-c) until all receiving units have a complete message, all receiving units are missing identical iterative packets or a predetermined timeout period has expired.

24. The system of claim 21, wherein the inter-unit iterative packet sharing protocol is a push method for sharing iterative packets, the plurality of receiver units have an execution hierarchy including an ordered set of the plurality of receiver units, wherein the method further comprises:
a) all the receiving units sending to the other receiving units a request for any missing iterative packets;
b) a top receiving unit sending to the other receiving units requests for one or more top receiving unit missing iterative packets;
c) determining a receiving unit with the most complete set of iterative packets and designating the determined receiving unit as the lead receiving unit;
d) the lead receiving unit sending to the other receiving units one or more of the missing iterative packets; and
e) iteratively performing steps a)-d) until all receiving units have a complete message, all receiving units are missing identical iterative packets or a predetermined timeout period has expired.
